(19) United States
(12) Patent Application Publication
(10) Pub. No.: US 2001/0021997 A1
(43) Pub. Date: Sep. 13, 2001

(54) Multichannel-type radio frequency modulation circuit

(75) Inventor: Jong Jin Lee, Suwon (KR)

Correspondence Address: LOWE HAUPTMAN GOPSTEIN GILMAN & BERNER, LLP, 1700 Diagonal Road, Suite 310, Alexandria, VA, 22314, US

(73) Assignee: SAMSUNG ELECTRO-MECHANICS CO., LTD.

(21) Appl. No.: 09/729,252

(22) Filed: Dec. 5, 2000

(30) Foreign Application Priority Data
Mar. 7, 2000 (KR) 2000-11349

(51) Int. Cl. H04N 7/173

(52) U.S. Cl. 725/74; 725/100

(57) ABSTRACT

A multichannel-type radio frequency modulation circuit for a set-top box, comprising a switch turned on/off in response to a switching voltage for passing/blocking a radio frequency signal from a radio frequency input terminal to a radio frequency output terminal, a modulation part enabled in response to operating voltages for modulating input audio signals and video signals into television signals at a plurality of channels, respectively, and a mixer for mixing the television signals modulated by the modulation part respectively with the radio frequency signal passed by the switch and outputting the resulting signals respectively to connected televisions via the radio frequency output terminal. The multichannel-type radio frequency modulation circuit is configured in a multichannel modulation manner in the set-top box such that a plurality of televisions receive broadcasting signals at different channels via the radio frequency modulation circuit.

### BACKGROUND OF THE INVENTION

1. Field of the Invention

The present invention relates in general to radio frequency modulation circuits of a multichannel type, and more particularly to a multichannel-type radio frequency modulation circuit which is configured in a multichannel modulation manner in a cable set-top box or Internet set-top box such that a plurality of televisions receive broadcasting signals at different channels via the radio frequency modulation circuit.

2. Description of the Prior Art

A variety of broadcasting services such as a ground-wave broadcasting service, satellite broadcasting service, Internet broadcasting service, etc. have recently been provided via a cable. Further, the number of televisions in each home is on a gradually increasing trend.

Generally, a cable set-top box or Internet set-top box is a kind of receiver capable of receiving a ground-wave broadcast, satellite broadcast, Internet broadcast, etc. via a cable, the construction of which is shown in block form in FIG. 1 herein. As shown in FIG. 1, the set-top box comprises a tuner 110 for tuning the set-top box to a desired channel to receive a broadcasting signal of the desired channel through a cable input terminal C-in, a channel demodulator 120 for demodulating an output signal from the tuner 110 into an audio signal AS and video signal VS, and a radio frequency (RF) modulation circuit 130 for modulating an output signal from the channel demodulator 120 into a television signal, mixing the modulated television signal with an RF signal from an RF input terminal RF-in and outputting the resulting signal to a connected television via an RF output terminal RF-out.

With reference to FIG. 2, there is shown in block form the construction of the conventional RF modulation circuit 130 in FIG. 1. As shown in this drawing, the conventional RF modulation circuit 130 includes a switch 131 turned on/off in response to a switching voltage Vsw for passing/blocking the RF signal from the RF input terminal RF-in to the RF output terminal RF-out, a modulator 132 enabled in response to an operating voltage Vcc for modulating the audio and video signals AS and VS from the channel demodulator 120 into the television signal, and a mixer 133 for mixing the television signal modulated by the modulator 132 with the RF signal passed by the switch 131 and outputting the resulting signal to the connected television via the RF output terminal RF-out.

The conventional RF modulation circuit for the set-top box with the above-mentioned construction is adapted to provide only one channel. In this regard, for a plurality of televisions in one home, they cannot help receiving a broadcast of only one channel via the conventional RF modulation circuit. As a result, a user has no choice but to view the same broadcast on all the televisions.

### SUMMARY OF THE INVENTION

Therefore, the present invention has been made in view of the above problem, it is an object of the present invention to provide a multichannel-type radio frequency modulation circuit which is configured in a multichannel modulation manner in a cable set-top box or Internet set-top box such that a plurality of televisions receive broadcasting signals at different channels via the radio frequency modulation circuit.

In accordance with the present invention, the above and other objects can be accomplished by a provision of a multichannel-type radio frequency modulation circuit for a set-top box, comprising a switch turned on/off in response to a switching voltage for passing/blocking a radio frequency signal from a radio frequency input terminal to a radio frequency output terminal; modulation means enabled in response to operating voltages for modulating input audio signals and video signals into television signals at a plurality of channels, respectively; and a mixer for mixing the television signals modulated by the modulation means respectively with the radio frequency signal passed by the switch and outputting the resulting signals respectively to connected televisions via the radio frequency output terminal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a general set-top box;

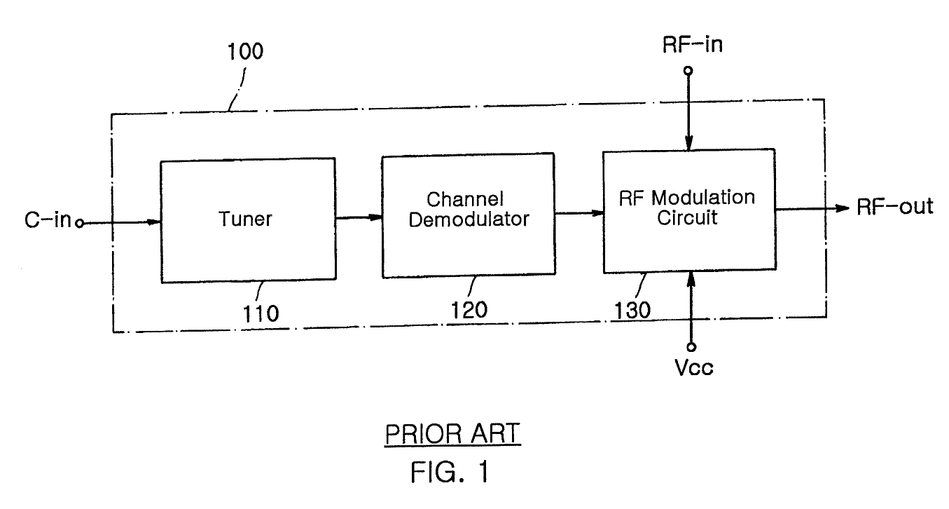

FIG. 2 is a block diagram showing the construction of a conventional radio frequency modulation circuit in FIG. 1;

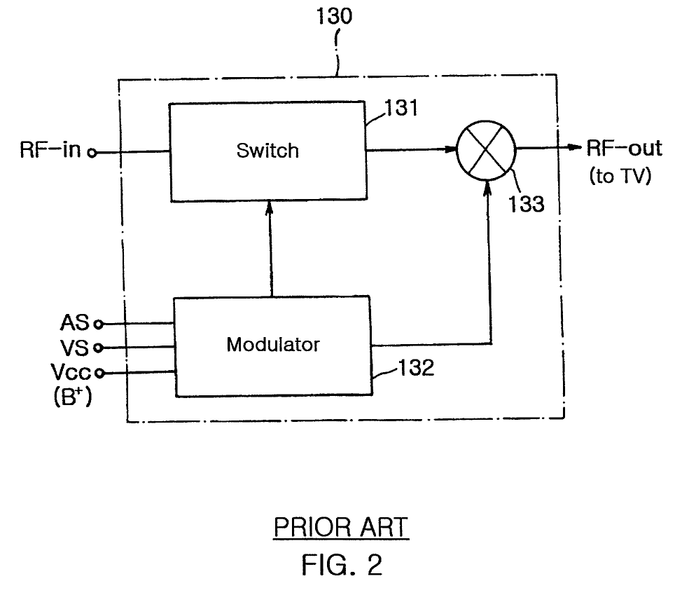

FIG. 3 is a block diagram showing the construction of a radio frequency modulation circuit in accordance with the present invention; and

FIG. 4 is a block diagram showing an embodiment of the radio frequency modulation circuit in FIG. 3.

### DETAILED DESCRIPTION OF THE PREFERRED EMBODIMENTS

In the drawings, some parts are substantially the same in construction and operation and they are thus denoted by the same reference numerals.

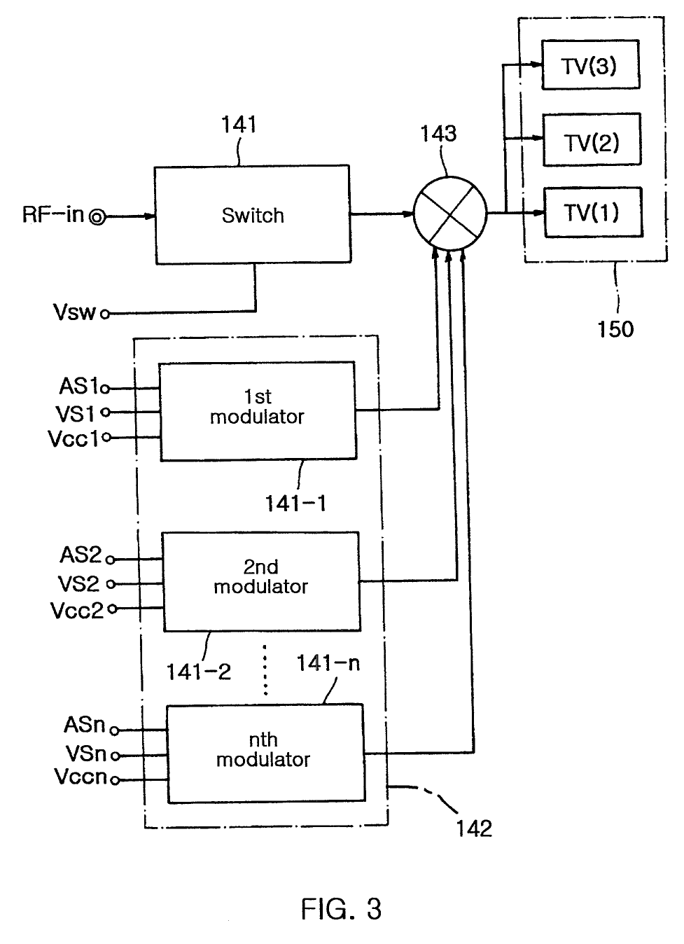

With reference to FIG. 3, there is shown in block form the construction of a radio frequency (RF) modulation circuit in accordance with the present invention, which is exemplarily applied to a cable set-top box. As shown in this drawing, the RF modulation circuit comprises a switch 141 turned on/off in response to a switching voltage Vsw for passing/blocking an RF signal from an RF input terminal RF-in to an RF output terminal RF-out. A modulation part 142 is enabled in response to operating voltages Vcc1˜Vccn to modulate input audio signals AS1˜ASn and video signals VS1˜VSn into television signals at a plurality of channels, respectively. A mixer 143 acts to mix the television signals modulated by the modulation part 142 respectively with the RF signal passed by the switch 141 and output the resulting signals respectively to connected televisions via the RF output terminal RF-out.

The modulation part 142 is provided with a plurality of modulators 141-1˜141-n, each of which is enabled in response to a corresponding one of the operating voltages Vcc1˜Vccn to modulate a corresponding one of the input audio signals AS1˜ASn and a corresponding one of the input video signals VS1˜VSn into a corresponding one of the television signals at the plurality of channels. Preferably, the plurality of channels are set to be independent of one another.

The switching voltage Vsw is supplied in common with the operating voltages Vcc1˜Vccn. In this case, when the operating voltages Vcc1˜Vccn are turned on (supplied), the switching voltage Vsw is turned on (supplied), too. Alternatively, the switching voltage Vsw may be supplied separately from the operating voltages Vcc1˜Vccn. In this case, the switching voltage Vsw is turned on (supplied) or off (blocked) irrespective of whether the operating voltages Vcc1˜Vccn are turned on (supplied).

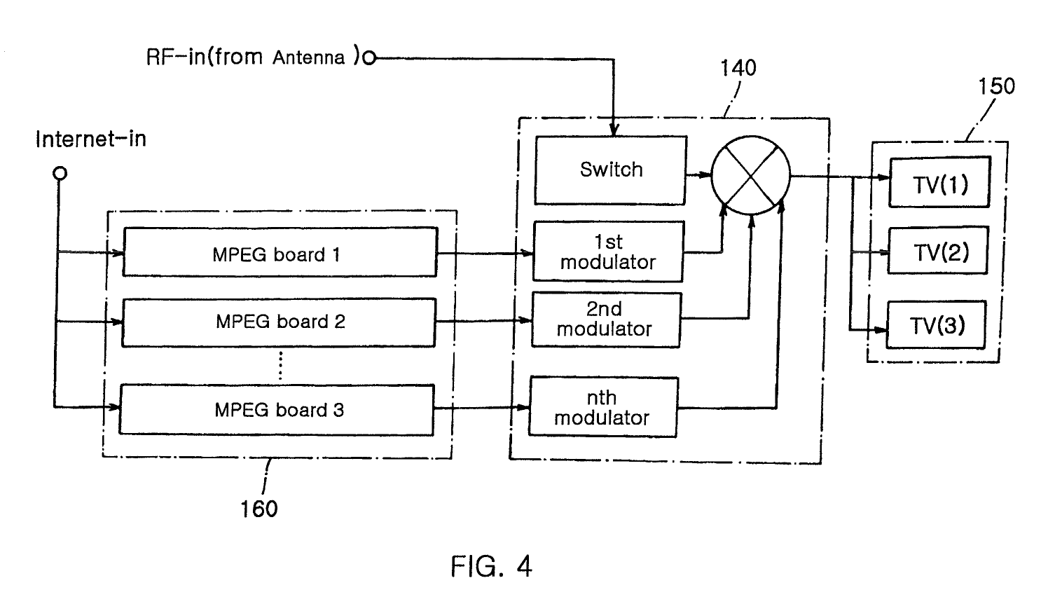

According to the present invention, the RF modulation circuit, which is applied to the cable set-top box as shown in FIG. 3, may be similarly applied to an Internet set-top box as shown in FIG. 4.

FIG. 4 is a block diagram showing an embodiment of the RF modulation circuit in FIG. 3, which is exemplarily applied to the Internet set-top box. The RF modulation circuit, denoted by the reference numeral 140 in FIG. 4, is configured to receive audio and video signals from MPEG boards 160 that receive and process Internet signals Internet-in.

Now, a detailed description will be given of the operation of the RF modulation circuit with the above-stated construction in accordance with the present invention.

The RF modulation circuit of the present invention is applied for input signal modulation in a cable set-top box or Internet set-top box that allows a user to receive a variety of broadcasting services provided via a cable, such as a ground-wave broadcasting service, satellite broadcasting service, Internet broadcasting service, etc., through televisions. This RF modulation circuit comprises a plurality of output channels at which input signals are demodulated and transmitted to different televisions, respectively. Therefore, a user can view desired broadcasts of different channels through a plurality of televisions with the aid of a single RF modulation circuit, or set-top box.

Referring again to FIG. 3, the switching voltage Vsw is supplied to the RF modulation circuit in common with or separately from the operating voltages Vcc1˜Vccn.

In the case where the switching voltage Vsw is supplied to the RF modulation circuit in common with the operating voltages Vcc1˜Vccn, the switch 141 in the RF modulation circuit is turned off and the modulation part 142, or the plurality of modulators 141-1˜141-n, in the RF modulation circuit are enabled respectively in response to the operating voltages Vcc1˜Vccn.

As a result, the RF signal from the RF input terminal RF-in is blocked by the switch 141, and the input audio signals AS1˜ASn and video signals VS1˜VSn are modulated into the television signals at the corresponding set channels by the corresponding modulators 141-1˜141-n, respectively. The respective channel signals modulated by the modulators 141-1˜141-n are transmitted to the corresponding connected televisions through the mixer 143. Hence, a user can view desired broadcasts of different channels through a plurality of televisions that receive modulated signals over the different channels, respectively.

Notably, the input audio signals AS1˜ASn and video signals VS1˜VSn are provided from a specific internal circuit block in a set-top box to which the RF modulation circuit of the present invention is applied, according to the type of the set-top box. As an example, in the case where the RF modulation circuit of the present invention is applied to the cable set-top box as shown in FIG. 3, the input audio signals AS1˜ASn and video signals VS1˜VSn are provided from a tuner. As another example, in the case where the RF modulation circuit of the present invention is applied to the Internet set-top box as shown in FIG. 4, the input audio signals AS1˜ASn and video signals VS1˜VSn are provided from the MPEG boards 160.

On the other hand, the switching voltage Vsw may be supplied to the RF modulation circuit separately from the operating voltages Vcc1˜Vccn. In this case, the modulation part 142, or the plurality of modulators 141-1˜141-n, in the RF modulation circuit are enabled respectively in response to the operating voltages Vcc1˜Vccn.

Accordingly, the input audio signals AS1˜ASn and video signals VS1˜VSn are modulated into the television signals at the corresponding set channels by the corresponding modulators 141-1˜141-n, respectively. The respective channel signals modulated by the modulators 141-1˜141-n are transmitted to the corresponding connected televisions through the mixer 143.

Notably, the RF signal from the RF input terminal RF-in is passed to the mixer 143 via the switch 141 if the switching voltage Vsw is supplied to the RF modulation circuit, and blocked by the switch 141 if the switching voltage Vsw is not supplied to the RF modulation circuit.

The mixer 143 mixes the television signals modulated by the modulation part 142 respectively with the RF signal passed by the switch 141 and transmits the resulting signals respectively to the connected televisions via the RF output terminal RF-out. Therefore, a user can view desired broadcasts of different channels through a plurality of televisions that receive modulated signals over the different channels, respectively.

As described above, the RF modulation circuit of the present invention can be applied to a set-top box regardless of the type of a system for supplying the switching voltage Vsw and the operating voltages Vcc1˜Vccn. A user can view desired broadcasts of different channels through a plurality of televisions connected to a single set-top box, more particularly a single RF modulation circuit.

As apparent from the above description, the present invention provides a multichannel-type RF modulation circuit which is configured in a multichannel modulation manner in a cable set-top box or Internet set-top box such that a plurality of televisions receive broadcasting signals at different channels via the RF modulation circuit.

Further, a user can view desired broadcasts of different channels through a plurality of televisions with the aid of a single set-top box, more particularly a single RF modulation circuit. Therefore, the present invention has the effect of satisfying customers' wants and thus securing the competitiveness of set-top boxes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multichannel-type radio frequency modulation circuit for a set-top box, comprising:
a switch turned on/off in response to a switching voltage for passing/blocking a radio frequency signal from a radio frequency input terminal to a radio frequency output terminal;
modulation means enabled in response to operating voltages for modulating input audio signals and video signals into television signals at a plurality of channels, respectively; and
a mixer for mixing the television signals modulated by said modulation means respectively with the radio frequency signal passed by said switch and outputting the resulting signals respectively to connected televisions via said radio frequency output terminal.

2. The multichannel-type radio frequency modulation circuit as set forth in claim 1, wherein said modulation means includes a plurality of modulators, each of said modulators being enabled in response to a corresponding one of said operating voltages to modulate a corresponding one of said input audio signals and a corresponding one of said input video signals into a corresponding one of said television signals at said plurality of channels, said plurality of channels being set to be independent of one another.
